(19) United States
(12) Patent Application Publication
(10) Pub. No.: US 2022/0189254 A1
(43) Pub. Date: Jun. 16, 2022

(54) INFORMATION PROCESSING PROGRAM, INFORMATION PROCESSING DEVICE, AND INFORMATION PROCESSING SYSTEM

(71) Applicant: CYGAMES, INC., Tokyo (JP)

(72) Inventors: Hidenori Sugihara, Tokyo (JP); Atsushi Yamazaki, Tokyo (JP); Akihito Isayama, Tokyo (JP)

(73) Assignee: CYGAMES, INC., Tokyo (JP)

(21) Appl. No.: 17/646,968

(22) Filed: Jan. 4, 2022

Related U.S. Application Data
(63) Continuation of application No. PCT/JP2020/024949, filed on Jun. 25, 2020.

(30) Foreign Application Priority Data
Jul. 5, 2019 (JP) 2019-126504

(51) Int. Cl. G07F 17/32

(52) U.S. Cl. CPC G07F 17/3262; G07F 17/329; G07F 17/323; G07F 17/3244

(57) ABSTRACT

An information processing program causes a computer to realize: a main lottery function for awarding a player a first game element that is drawn from among at least one to-be-drawn first game element on the basis of an operation performed by the player; a trade function for consuming a predetermined second game element and awarding the player a first game element corresponding to the predetermined second game element; a strengthening function for consuming the predetermined second game element and strengthening a first game element corresponding to the predetermined second game element; and a subsidiary lottery function for awarding, on the basis of execution of a process regarding the main lottery function, the player a second game element that is drawn from among at least one to-be-drawn second game element including the predetermined second game element corresponding to the at least one to-be-drawn first game element.

### TECHNICAL FIELD

The present invention relates to information processing programs, information processing devices, and information processing systems.

### BACKGROUND ART

There are well-known computer games in which various characters are used. In such a game, it is also common that a lottery is executed in the game and the player is awarded a drawn character. Note that such a lottery goes by the name of, for example, “gacha”.

An example of a technique regarding lotteries in such a game is disclosed in PTL 1. The technique disclosed in PTL 1 provides not only a main lottery, which is a lottery for awarding a character to the player, but also a subsidiary lottery, which is a lottery for further awarding an item to the player who has executed the main lottery. In this manner, the fun of a lottery can be enhanced by awarding an item in the form of what is called a bonus or a prize (i.e., free gift).

Publication of Japanese Patent No. 5817900

### DISCLOSURE OF THE INVENTION

### Problems to be Solved by the Invention

As described above, general techniques described in PTL 1, etc. provide a subsidiary lottery accompanying a main lottery. However, a game element (e.g., an item in PTL 1) awarded in such a subsidiary lottery has limited relevance to a game element (e.g., a character in PTL 1) awarded in the main lottery, which demeans the subsidiary lottery as a mere function for awarding a bonus or a prize. For this reason, it is considered that there is room for improvement from the viewpoint of enhancing the fun of a lottery.

The present invention has been conceived in light of these circumstances, and an object thereof is to further enhance the fun of a lottery in the case where a plurality of kinds of lotteries are executed.

### Means for Solving the Problems

In order to achieve the above-described object, an information processing program according to one aspect of the present invention causes a computer to realize: a main lottery function for awarding a player a first game element that is drawn from among at least one to-be-drawn first game element on the basis of an operation performed by the player; a trade function for consuming a predetermined second game element and awarding the player a first game element corresponding to the predetermined second game element; a strengthening function for consuming the predetermined second game element and strengthening a first game element corresponding to the predetermined second game element; and a subsidiary lottery function for awarding, on the basis of execution of a process regarding the main lottery function, the player a second game element that is drawn from among at least one to-be-drawn second game element including the predetermined second game element corresponding to the at least one to-be-drawn first game element.

### Effects of the Invention

According to the present invention, in the case where a plurality of kinds of lotteries are executed, the fun of a lottery can be further enhanced.

### BRIEF DESCRIPTION OF THE DRAWINGS

FIG. 1 is a block diagram showing the overall configuration of an information processing system according to an embodiment of the present invention.

FIG. 2 is a block diagram showing the hardware configuration of a server and the hardware configuration of a player terminal included in the information processing system according to the embodiment of the present invention.

FIG. 3 is a functional block diagram showing, of the functional configurations of the server and the player terminal in FIG. 2, functional configurations for executing a parameter management process.

FIG. 4 is a flowchart for illustrating a flow of the parameter management process executed by the server in FIG. 2 having the functional configurations in FIG. 3.

FIG. 5 is a flowchart for illustrating a flow of the parameter management process executed by the player terminal in FIG. 2 having the functional configurations in FIG. 3.

FIG. 6 is a diagram showing an example of a selection screen that is displayed in the parameter management process and that is related to a main lottery and a subsidiary lottery accompanying the main lottery.

FIG. 7 is a diagram showing another example of the selection screen that is displayed in the parameter management process and that is related to the main lottery and the subsidiary lottery accompanying the main lottery.

FIG. 8 is a diagram showing an example of a screen that is displayed in the parameter management process and that allows selection of a special item corresponding to any character.

FIG. 9 is a diagram showing an example of a screen that is displayed in the parameter management process and that displays subsidiary lottery history.

### PREFERRED MODE FOR CARRYING OUT THE INVENTION

An embodiment of the present invention will be described below with reference to the drawings.

### [Overall Configuration of System]

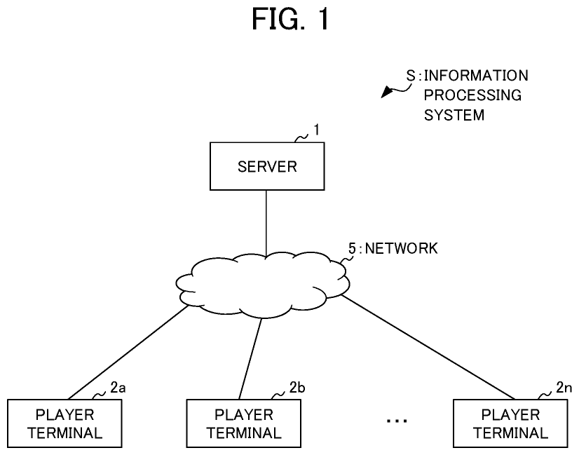

The overall configuration of this embodiment will be described with reference to FIG. 1. FIG. 1 is a block diagram showing the overall configuration of an information processing system S according to this embodiment.

As shown in FIG. 1, the information processing system S is configured to include a server 1, n (n is any integer equal to or greater than one) player terminals 2, and a network 5.

The information processing system S is what is called a client-server system. The information processing system S is realized by mutually carrying out communication between the n player terminals 2 acting as clients and the server 1 via the network 5.

The server 1 is realized, for example, by a server device. Furthermore, the player terminals 2 are realized, for example, by smartphones, stationary or portable game machines, or personal computers. Furthermore, the network 5 is realized, for example, by a network such as a LAN (Local Area Network), the Internet, or a mobile phone network, or a network formed by combining these kinds of networks.

In the drawings, a player terminal 2a, a player terminal 2b, and a player terminal 2n are shown as the n player terminals 2. It should be noted, however, that in the following description, these n player terminals 2 will be simply referred to as the “player terminals 2”, with the reference signs partially omitted, in the case where no distinction is made thereamong.

### Outline of Present Embodiment

Next, the outline of processes executed by the information processing system S according to this embodiment shown in FIG. 1 will be described.

The purpose of the information processing system S is to enhance the fun of a lottery in the case where a plurality of kinds of lotteries are executed.

For this purpose, a parameter management process is executed in the information processing system S through cooperative operation between the server 1 and each of the player terminals 2. Here, the parameter management process is composed of a series of processes for executing a plurality of kinds of lotteries and thereby not only awarding a player game elements relevant to each other but also managing predetermined parameters in relation to these lotteries.

In this parameter management process, the information processing system S awards, in a main lottery, a player a first game element that has been drawn from among to-be-drawn first game elements on the basis of the player's operation.

In addition, the information processing system S awards, in a subsidiary lottery, the player a second game element that has been drawn, on the basis of the execution of a main-lottery-related process, from among to-be-drawn second game elements including predetermined second game elements corresponding to the to-be-drawn first game elements.

According to such a parameter management process, the predetermined second game elements corresponding to the first game elements to be drawn in the main lottery can be set as objects to be drawn in the subsidiary lottery. By doing so, the relevance among the plurality of kinds of lotteries including the main lottery and the subsidiary lottery can be increased, whereby the plurality of kinds of lotteries are made more closely related to one another.

Therefore, it is possible to solve the problem with the above-described general techniques in that a plurality of kinds of lotteries have limited relevance to each other, which demeans the subsidiary lottery as a mere function for awarding a bonus or a prize. In short, according to the information processing system S, in the case where a plurality of kinds of lotteries are executed, the fun of a lottery can be further enhanced.

In addition, in the parameter management process, the information processing system S awards the player a first game element corresponding to a predetermined second game element by consuming the predetermined second game element. Moreover, the information processing system S strengthens a first game element corresponding to a predetermined second game element by consuming the predetermined second game element.

For this reason, the player can use means for acquiring a desired first game element by using a predetermined second game element even if he/she fails to win the desired first game element in the main lottery. Alternatively, the player can use means for retaining a predetermined second game element until winning a desired first game element in the main lottery and then using the retained predetermined second game element to strengthen the desired first game element when the player wins that first game element in the main lottery.

Thus, the player is given more options with wider variety of uses of a predetermined second game element and can be more strategic in drawing a lottery.

In other words, the information processing system S can further enhance the fun of a lottery in the case where a plurality of kinds of lotteries are executed.

The outline of this embodiment has been described above.

Note that the above-described first game elements and second game elements include any elements constituting the game and are not limited to particular game elements. In the following description, it is assumed as an example that the first game elements are “characters” in the game and the second game elements are “items” in the game. Also, hereinafter, the above-described predetermined second game elements are referred to as “special items”.

It is repeated, however, that the characters and items are mere examples for the sake of explanation, and other game elements can also serve as the first game elements and second game elements. Examples of the first game elements and second game elements may include other game elements, such as a skill bestowed on a character, a right to proceed with a subscenario, a right to appreciate special rendering in the game, a card used in a card game, and in-game currency. In short, any game elements can be used as the first game elements and second game elements according to the game specifics and the intent of the game administrator, etc.

### [Hardware Configuration]

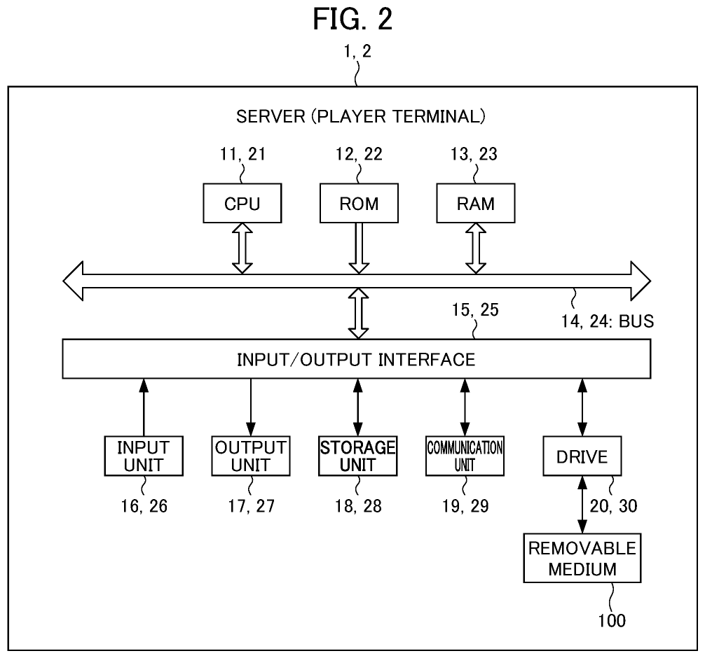

Next, the hardware configuration according to this embodiment will be described with reference to FIG. 2. FIG. 2 is a block diagram showing the hardware configuration of the server 1 and the hardware configuration of the player terminal 2 included in the information processing system S according to the embodiment of the present invention. In the figure, reference signs corresponding to the hardware of the server 1 are shown without adding parentheses, and reference signs corresponding to the hardware of the player terminal 2 are shown with added parentheses.

First, the hardware configuration of the server 1 will be described. As shown in FIG. 2, the server 1 includes a CPU (Central processing unit) 11, a ROM (Read Only Memory) 12, a RAM (Random Access Memory) 13, a bus 14, an input/output interface 15, an input unit 16, an output unit 17, a storage unit 18, a communication unit 19, and a drive 20.

The CPU 11 executes various kinds of processes according to programs recorded in the ROM 12 or programs loaded from the storage unit 18 into the RAM 13.

The RAM 13 also stores, as appropriate, data, etc. needed for the CPU 11 to execute various kinds of processes.

The CPU 11, the ROM 12, and the RAM 13 are connected to each other via the bus 14. The input/output interface 15 is also connected to the bus 14. The input unit 16, the output unit 17, the storage unit 18, the communication unit 19, and the drive 20 are connected to the input/output interface 15.

The input unit 16 is formed of various kinds of buttons, a touchscreen, a microphone, or the like, and accepts input of various kinds of information in accordance with instruction operations performed by the administrator (e.g., game administrator) of the server 1. Alternatively, the input unit 16 may be realized by an input device, such as a keyboard or a mouse, that is independent of the main unit accommodating the other units of the server 1.

The output unit 17 outputs image data or music data to a display, a speaker, or the like. The image data or music data output from the output unit 17 is output from the display, the speaker, or the like in a form recognizable by the player, such as an image or music.

The storage unit 18 is formed of a semiconductor memory, such as a DRAM (Dynamic Random Access Memory), and stores various kinds of data.

The communication unit 19 realizes communication that is carried out with other devices. For example, the communication unit 19 carries out communication mutually with each of the player terminals 2 via the network 5.

The drive 20 is provided as needed and as appropriate. A removable medium 100 formed of a magnetic disk, an optical disk, a magneto-optical disk, a semiconductor memory, or the like is loaded, as appropriate, in the drive 20. The removable medium 100 stores programs and various kinds of data, such as image data, for executing the game. The programs and the various kinds of data, such as image data, read by the drive 20 from the removable medium 100 are installed in the storage unit 18, as needed.

Next, the hardware configuration of the player terminal 2 will be described. As shown in FIG. 2, the player terminal 2 includes a CPU 21, a ROM 22, a RAM 23, a bus 24, an input/output interface 25, an input unit 26, an output unit 27, a storage unit 28, a communication unit 29, and a drive 30. These units individually have functions equivalent to those of the units having the same names and different reference signs in the server 1 described above. Thus, repeated descriptions will be omitted.

Note that, in the case where the player terminal 2 is configured as a portable terminal, the hardware units of the player terminal 2, a display, and a speaker, as well as a battery for supplying power to these units and devices, may be realized in the form of an integrated device.

### [Functional Configurations]

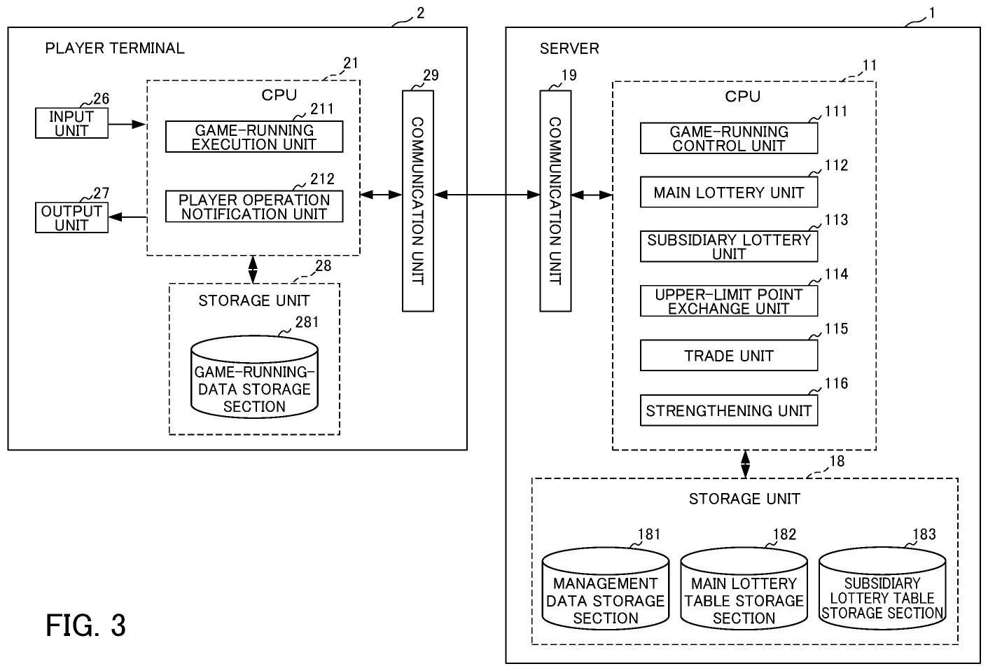

Next, the functional configurations of the server 1 and the functional configurations of the player terminal 2 illustrated in FIGS. 1 and 2 will be described with reference to FIG. 3. FIG. 3 is a block diagram showing, of the functional configurations of the server 1 and the functional configurations of the player terminal 2, functional configurations for executing the above-described parameter management process.

First, the functional configurations of the player terminal 2 will be described.

When the parameter management process is executed, the CPU 21 functions as a game-running execution unit 211 and a player operation notification unit 212, as shown in FIG. 3. Furthermore, a game-running-data storage section 281 is set in an area of the storage unit 28. These functional blocks transmit/receive information to/from one another, as needed.

The game-running execution unit 211 executes processes for running the game. The game-running execution unit 211 runs the game on the basis of: game software included in the game-running-data storage section 281, which will be described below; specifics of the player's game-related operations that are input from the input unit 26 and that are reported from the player operation notification unit 212, which will be described below; and results of processes executed in the functional blocks included in the server 1, i.e., the results being reported from a game-running control unit 111, which will be described below.

Furthermore, as the game is run, the game-running execution unit 211 executes a control process for generating game images from image data included in the game-running-data storage section 281, which will be described below, and displaying the generated images on the display connected to the output unit 27. Similarly, as the game is run, the game-running execution unit 211 executes a control process for generating game music (including effect sounds) and audio from music data and audio data included in the game-running-data storage section 281, which will be described below, and outputting the generated game music and audio from the speaker connected to the output unit 27.

Here, in this embodiment, the predetermined parameters in the game run by the game-running execution unit 211 are managed by the server 1. For example, parameters managed by the server 1 include: a parameter indicating what game elements (e.g., a character serving as a first game element, an item serving as a second game element, etc.) are possessed by the player; a parameter indicating the states, etc. of the possessed characters; a parameter indicating past game results such as wins and losses in the game; a parameter corresponding to the amount of in-game currency possessed in the game; etc.

For this reason, when a process involving changes in these predetermined parameters occurs in the game, the game-running execution unit 211 carries out communication with the server 1 to update the parameters managed by the server 1. Then, the game-running execution unit 211 receives the updated parameters from the server 1 and continues to run the game according to the updated parameters.

For example, processes involving changes in the predetermined parameters include: the main lottery and the subsidiary lottery for acquiring characters and items; trading in special items for a character; strengthening of a character by using special items; an exchange between a character and exchange points, which will be described below; wins and losses in the game; acquisition of an item; etc. For this reason, when any of these processes involving changes in the predetermined parameters occurs, the game-running execution unit 211 carries out communications with the server 1 to update the parameters.

This communication by means of the game-running execution unit 211 with the server 1 is carried out by using the communication unit 29. Although the network 5 for realizing communication is present between the player terminal 2 and the server 1, as described above with reference to FIG. 1, the network 5 is not shown in FIG. 3.

In this embodiment, it is assumed that the game-running execution unit 211 runs, as a game, an RPG (Role-playing game) in which the player fights a battle, etc., by using a character possessed by the player himself/herself.

It should be noted, however, that an RPG is merely an example of games that can be run in this embodiment. A wide variety of games, other than an RPG, using a wide variety of game elements can be run in this embodiment. In short, the applicable scope of this embodiment is not limited to an RPG. In addition, games that can be run in this embodiment may be games executed by a single player alone and so-called multi-player games executed by a plurality of players.

The player operation notification unit 212 notifies the game-running execution unit 211 of the specifics of selection made by the player. For example, the player operation notification unit 212 accepts, on the basis of the player's operation input from the input unit 26: a lottery instruction operation for executing the main lottery (and the accompanying subsidiary lottery); a trade instruction operation for trading in special items for a character; a strengthening instruction operation for strengthening a character by using special items; an exchange instruction operation, which will be described below, for exchanging exchange points for a character; and various types of other selection operations and various types of other instruction operations in the game, etc.

Then, the player operation notification unit 212 notifies the game-running execution unit 211 of the specifics of the accepted player's operation. Upon accepting this notification, the game-running execution unit 211 continues to run the game on the basis of the reported operation specifics.

The game-running-data storage section 281 stores various kinds of data needed for the game-running execution unit 211 to run the game (here, an RPG as described above). Examples of the various kinds of data for running the game include game software constituted of programs for executing the game, as well as image data, music data, and audio data for generating game images and sounds. Furthermore, in the case where at least a portion of a character, a background, or the like is displayed by using three-dimensional computer graphics in the game, the game-running-data storage section 281 also stores polygon data, texture data, etc. for realizing presentation based on three-dimensional computer graphics.

Although these various kinds of data for running the game may be stored only in the game-running-data storage section 281 of the storage unit 28, the various kinds of data may be read by the drive 20 from the removable medium 100, as appropriate.

Alternatively, these various kinds of data may be transmitted to the player terminal 2, as appropriate, from the server 1 or from another device that is not shown, such as a server, by way of communication via the communication unit 29. That is, these various kinds of data may be downloaded, as needed and as appropriate, when the game is installed or when the game is updated.

Next, the functional configurations of the server 1 will be described.

When the parameter management process is executed, the CPU 11 functions as a game-running control unit 111, a main lottery unit 112, a subsidiary lottery unit 113, an upper-limit point exchange unit 114, a trade unit 115, and a strengthening unit 116, as shown in FIG. 3. Furthermore, a management data storage section 181, a main lottery table storage section 182, and a subsidiary lottery table storage section 183 are set in an area of the storage unit 18. These functional blocks transmit/receive information to/from one another, as needed.

The game-running control unit 111 communicates with the game-running execution unit 211 of the player terminal 2 and performs cooperative operation with each of the functional blocks of the server 1, thereby performing control regarding the game (here, RPG as described above) run in the player terminal 2.

For example, when a process involving changes in the predetermined parameters occurs in the game, the game-running control unit 111 communicates with the game-running execution unit 211. Then, the game-running control unit 111 changes the predetermined parameters through cooperative operation with each of the functional blocks of the server 1 and notifies the game-running execution unit 211 of the changed predetermined parameters and other information about game running.

Upon receiving this notification, the game-running execution unit 211 continues to run the game on the basis of the notification from the game-running control unit 111. More specifically, the game-running execution unit 211 runs the game on the basis of the reported predetermined parameters, etc., generates images and sounds corresponding to the specifics of the running of the game, and outputs the generated images and sounds from the output unit 27.

Furthermore, the game-running control unit 111 manages various kinds of data regarding the game. Various kinds of data regarding the game include, for example, the above-described predetermined parameters in the game, identification information, etc. regarding the player terminal 2 and the player. Data, such as the predetermined parameters, managed by the game-running control unit 111 is stored in the management data storage section 181 of the storage unit 18. In addition, this stored data is updated, as appropriate, by the game-running control unit 111 as the game is run. Note that the plurality of player terminals 2 are connected to the server 1, as described above with reference to FIG. 1. For this reason, data such as the predetermined parameters is stored for each of the player terminals 2 or for each of the players on the basis of identification information regarding the player terminals 2, identification information regarding the players, etc. It should be noted, however, that data such as some of the predetermined parameters may be managed as common data among the players.

Thus, this embodiment can realize game running through cooperative operation between the player terminal 2 and the server 1. Also, in this embodiment, since at least some of the processes regarding the game are executed at the server 1 as described above, it is possible to reduce the number of processes at the player terminal 2. In addition, because changes in data such as the predetermined parameters are made and managed at the server 1 in this embodiment, it is possible to prevent falsification of process specifics, parameters, etc. regarding the game at the player terminal 2.

The main lottery unit 112 executes the main lottery in the parameter management process. Here, in the main lottery, characters serving as the first game elements are objects that are to be drawn. These characters that are to be drawn may include all characters that are present in the game or may be certain characters determined by the game administrator. In addition, there may be characters, etc. that serve as objects to be drawn only in a predetermined time period.

Furthermore, a rarity (level of rarity) is set for each of the characters. Also, characters only with certain levels of rarity may serve as objects that are to be drawn. Note that the levels of rarity may include only two levels, “high” and “low”, or may include more than two levels. In the following description, it is assumed as an example that there are five levels of rarities including a first level of rarity, a second level of rarity, a third level of rarity, a fourth level of rarity, and a fifth level of rarity in that order from the lowest level of rarity to the highest level of rarity.

The main lottery, in which characters serve as to-be-drawn objects, is executed by this main lottery unit 112 on the basis of main lottery tables stored in the main lottery table storage section 182. In this embodiment, it is assumed as an example that the main lottery is executed as a two-step lottery.

Under this assumption, a rarity-level determination table is prepared first as one of the main lottery tables. In this rarity-level determination table, the winning probability for a higher level of rarity is set to be lower than the winning probability for a lower level of rarity. In other words, the winning probabilities for the levels of rarity are set such that a level of rarity is more difficult to win as the level of rarity is higher, and a level of rarity is easier to win as the level of rarity is lower.

In addition, in the case where only certain levels of rarity (e.g., the first level of rarity, the second level of rarity, and the third level of rarity) are set as to-be-drawn levels of rarity as described above, the values of winning probabilities for the other levels of rarity (e.g., the fourth level of rarity and the fifth level of rarity) are set as zero, or, in the first place, the rarity-level determination table is prepared so as not to include the other levels of rarity as levels of rarity that are to be won.

In addition, character determination tables are prepared as the main lottery tables so that the character determination tables correspond to respective levels of rarity. In these character determination tables, characters with the same level of rarity may be set to have the same winning probability or to have winning probabilities different from one another.

In addition, in the case where only certain characters (e.g., certain characters determined by the game administrator) are set as to-be-drawn objects as described above, the values of winning probability for the other characters (e.g., characters other than the certain characters determined by the game administrator) are set as zero, or, in the first place, the rarity-level determination table is prepared so as not to include the other levels of character as levels of character that are to be won.

Then, the main lottery unit 112 first determines a won level of rarity by executing a lottery in the main lottery by using the rarity-level determination table. Subsequently, the main lottery unit 112 determines a won character by executing a lottery by using the character determination table corresponding to the determined level of rarity. In this manner, the main lottery unit 112 can execute the main lottery. Then, the main lottery unit 112 notifies the game-running control unit 111 of the character that has been won in the main lottery. In addition, the game-running control unit 111 awards the player the reported character.

Note that the winning probabilities in these tables, as well as levels of rarity and characters included in the tables, can be modified, as appropriate, by the game administrator. It is also possible, for example, to change winning probabilities only in a fixed time period, add new characters, delete existing characters, etc.

In addition, instead of setting only certain levels of rarity and certain characters as levels of rarity and characters that are to be won, winning probabilities for these levels of rarity and characters may be set to be higher than the winning probabilities for the other levels of rarity and the other characters. By doing so, it is also possible, for example, to set the certain levels of rarity and certain characters to be easier to win in a time-limited event, etc. than in normal times.

As described above, in this embodiment, a two-step lottery is executed by preparing the rarity-level determination table and the character determination table corresponding to each of the levels of rarity. By doing so, in the case where only certain levels of rarity and certain characters are set as to-be-won levels of rarity and characters, in the case where the winning probabilities for the characters with a particular level of rarity are changed, and in the case where characters are added and deleted, the game administrator needs to do no more than change the corresponding tables and thus can be more relieved of taking the trouble of changing tables.

Without the present embodiment being limited to a two-step lottery, it is also possible to employ a single step lottery by preparing a table for allowing both a level of rarity and a character to be determined at a time. In this case, it is possible to reduce the trouble of preparing a plurality of tables.

The subsidiary lottery unit 113 executes the subsidiary lottery on the basis of the execution of “the main-lottery-related process”. The following description assumes, as an example, a case where a process for executing a lottery in the main lottery is treated as this main-lottery-related process. For this reason, when a lottery in the main lottery by means of the main lottery unit 112 ends, the subsidiary lottery unit 113 executes the subsidiary lottery.

It should be noted, however, that this is merely an example, and, for example, a process for granting the player a right to execute a lottery in the main lottery may be treated as this main-lottery-related process. It is assumed that the player has performed an operation, for example, for acquiring a right to execute the main lottery in return for consuming an item or virtual currency. Under this assumption, the game-running control unit 111 awards the player an item (e.g., lottery ticket) corresponding to the right to execute the main lottery. Then, when this item is awarded to the player, the subsidiary lottery unit 113 executes the subsidiary lottery.

Besides, for example, a process for accepting an instruction operation for executing the main lottery may be treated as this main-lottery-related process. In this case, the main lottery unit 112 executes the main lottery after the subsidiary lottery unit 113 has executed the subsidiary lottery.

In other words, although the subsidiary lottery is executed accompanying the main lottery, the subsidiary lottery does not necessarily need to be executed after the execution of the main lottery, and may be executed before the execution of the main lottery.

In addition, in the subsidiary lottery, items serving as the second game elements are objects to be drawn. Here, it is assumed as an example that special items are to-be-drawn objects. It is also assumed as an example that a special item is present so as to correspond to a certain character set as an object to be drawn in the main lottery.

For this reason, in the case where there are a plurality of the certain characters set as objects to be drawn in the main lottery, a plurality of the special items are present accordingly. For this reason, in the case where a plurality of the certain characters are present as described above, a special item that is selected on the basis of the player's selection operation and that corresponds to one of the characters is set as a to-be-drawn object. For this purpose, before executing the subsidiary lottery, the game-running control unit 111 allows the player to select a special item corresponding to one of the characters in the course of proceeding with the game.

The subsidiary lottery in which special items serve as to-be-drawn objects is executed by the subsidiary lottery unit 113 on the basis of a subsidiary lottery table stored in the subsidiary lottery table storage section 183. In this embodiment, it is assumed as an example that the subsidiary lottery is executed as a single step lottery.

For this purpose, in the subsidiary lottery table, for example, classes (arbitrary levels of classes, such as the special class, the first class, the second class . . . the lowest class) in a lottery, the winning probability for each of the classes, and the number of special items awarded to the player when each of the classes is won in the lottery are set in association with one another. In this case, the winning probability for a higher class is set to be lower than the winning probability for a lower class. In other words, the winning probabilities for the classes are set such that a class becomes more difficult to win as the class becomes higher, and a class becomes easier to win as the class becomes lower.

In addition, the number of special items awarded to the player when each of the classes is won is set such that the higher the class, the larger the number and that the lower the class, the smaller the number. Note that, for example, the number of awarded special items with the lowest class may be zero.

Then, the subsidiary lottery unit 113 executes a lottery by using the subsidiary lottery table in the subsidiary lottery and determines a won class. The subsidiary lottery unit 113 can execute the subsidiary lottery in this manner. Then, the subsidiary lottery unit 113 notifies the game-running control unit 111 of the number of special items, awarded to the player, corresponding to the class won in the subsidiary lottery. In addition, the game-running control unit 111 awards the player the reported number of special items.

The main lottery and the subsidiary lottery have been described above. Although one session of the main lottery and subsidiary lottery can be executed as one unit in this embodiment, it is also assumed that a plurality of sessions of the main lottery and subsidiary lottery can be executed in a row as one unit.

For example, it is assumed that ten lotteries can be executed in a row as one unit. Under this assumption, instead of merely executing the main lottery and the accompanying subsidiary lottery a plurality of times (e.g., ten times) in a row, one of the plurality of lotteries is executed as a special lottery. In the case where the main lottery and subsidiary lottery are executed in a row, for example, ten times, the main lottery and subsidiary lottery are normally executed nine times in a row, and at the tenth lottery, a main lottery with a guaranteed lowest to-be-won level of rarity (hereinafter, referred to as a “special main lottery”) and a subsidiary lottery with a guaranteed lowest to-be-won class (hereinafter, referred to as a “special subsidiary lottery”) are executed.

In the case of, for example, the special main lottery, the lowest level of rarity of character that is won is guaranteed, in which case characters with the first level of rarity and the second level of rarity are ruled out from characters to be won. For this purpose, if the first level of rarity or the second level of rarity is won in a lottery using the rarity-level determination table, the main lottery unit 112 executes a process for making a correction as if the third level of rarity were won and treats this situation as if the third level of rarity were won. By doing so, the lowest level of rarity of character that is won can be guaranteed. In addition, in another method, if the first level of rarity or the second level of rarity is won in a lottery using the rarity-level determination table, the main lottery unit 112 executes another lottery again by using the rarity-level determination table. Then, a lottery is repeated until a level of rarity equal to or higher than the third level of rarity is won. This method can guarantee the lowest level of rarity of the character that is won.

In addition, in the case of the special subsidiary lottery, the lowest class that is won is guaranteed (i.e., the smallest number of special items that are awarded in accordance with the class is guaranteed), in which case classes lower than the fourth class are ruled out from classes that are won. For this purpose, if a class lower than the fourth class, i.e., the fifth class or the sixth class, is won in a lottery using the subsidiary lottery table, the subsidiary lottery unit 113 executes a process for making a correction as if the fourth class were won and treats this situation as if the fourth class were won. By doing so, the lowest class that is won (i.e., the smallest number of special items that are awarded in accordance with the class) can be guaranteed. In addition, in another method, if a class lower than the fourth class, i.e., the fifth class or the sixth class, is won in a lottery using the subsidiary lottery table, the subsidiary lottery unit 113 executes another lottery again by using the subsidiary lottery table. Then, a lottery is repeated until a class equal to or higher than the fourth class is won. This method can guarantee the lowest class that is won (i.e., the smallest number of special items that are awarded in accordance with the class).

As described above, by executing a process for making a correction as if a predetermined level of rarity or a predetermined class were won or repeating a lottery, the special main lottery and the special subsidiary lottery can be realized by using the existing main lottery tables and subsidiary lottery table as is. In other words, it is not necessary to prepare separate tables for the special main lottery and the special subsidiary lottery.

Without the present embodiment being limited to this configuration, it is also acceptable to prepare separate tables for the special main lottery and the special subsidiary lottery. For example, tables in which winning probabilities for lower levels of rarity and lower classes are set as zero or tables not including lower levels of rarity and lower classes as to-be-won levels of rarity and classes may be prepared. In this case, it is not necessary to execute a process for making a correction as if a predetermined level of rarity and a predetermined class were won or to repeat a lottery.

When the number of times a lottery is executed in the main lottery reaches a fixed number, the upper-limit point exchange unit 114 awards the player a character to be drawn in the main lottery on the basis of the player's operation. This means that when the main lottery is executed a fixed number of times, the player is always awarded a character. In other words, an upper limit is set on the number of misses. By doing so, the player is prevented from missing the lottery a countless number of times and hence can be given a sense of security. Note that such an upper limit is called a “ceiling” in some cases.

In this embodiment, as an example, each time the main lottery unit 112 executes a lottery in the main lottery, the game-running control unit 111 awards “exchange points” to the player. Then, when a lottery in the main lottery is executed a fixed number of times (e.g., 300 times) and these exchange points reach a fixed number (e.g., 300 points), the upper-limit point exchange unit 114 awards the player a character to be drawn in the main lottery in return for consuming this fixed number of exchange points on the basis of the player's exchange instruction operation. Note that, in this case, the player can be given more options if he/she is allowed to arbitrarily select, as the awarded character, a character from among certain characters set as objects to be drawn in the main lottery.

The trade unit 115 consumes a fixed number (e.g., 150) of special items, thereby awarding the player a character corresponding to these special items. As described above, in the subsidiary lottery, a special item that is selected by the player and that corresponds to any character is assigned to the player. Then, the trade unit 115 consumes a fixed number of special items on the basis of the player's trade instruction operation, thereby awarding the player the character corresponding to these special items. In short, the trade unit 115 trades in special items for a character.

The strengthening unit 116 consumes a fixed number (e.g., 150) of special items, thereby strengthening the character that is possessed by the player and that corresponds to these special items. Here, it is assumed that to strengthen a character is, for example, to increase the level of rarity of the character by one level. For example, a character with the third level of rarity is upgraded to a character with the fourth level of rarity. Then, along with this strengthening, a parameter itself regarding the ability of the character or the upper limit value of the parameter at the time the level is raised is increased, a new skill is assigned to the character, and the character is equipped with a new item (e.g., powerful weapon exclusively prepared for the character), etc. More specifically, the strengthening unit 116 consumes a fixed number of special items on the basis of the player's strengthening instruction operation, thereby strengthening the character that is possessed by the player and that corresponds to these special items.

Thus, the player is given more options with a wider variety of uses of special items by means of the trade unit 115 and the strengthening unit 116 and can be more strategic in drawing a lottery.

The management data storage section 181 stores various kinds of data, regarding the game, managed by the game-running control unit 111. Details of this data have been described above in explaining the game-running control unit 111, and another description of this data is omitted.

The main lottery table storage section 182 stores the main lottery tables. These main lottery tables include the rarity-level determination table and the character determination tables, as described above. Details of these tables have been described above in explaining the main lottery unit 112, and another description of these tables is omitted.

The subsidiary lottery table storage section 183 stores the subsidiary lottery table. Details of this subsidiary lottery table have been described above in explaining the subsidiary lottery unit 113, and another description of this subsidiary lottery table is omitted.

### [Operation]

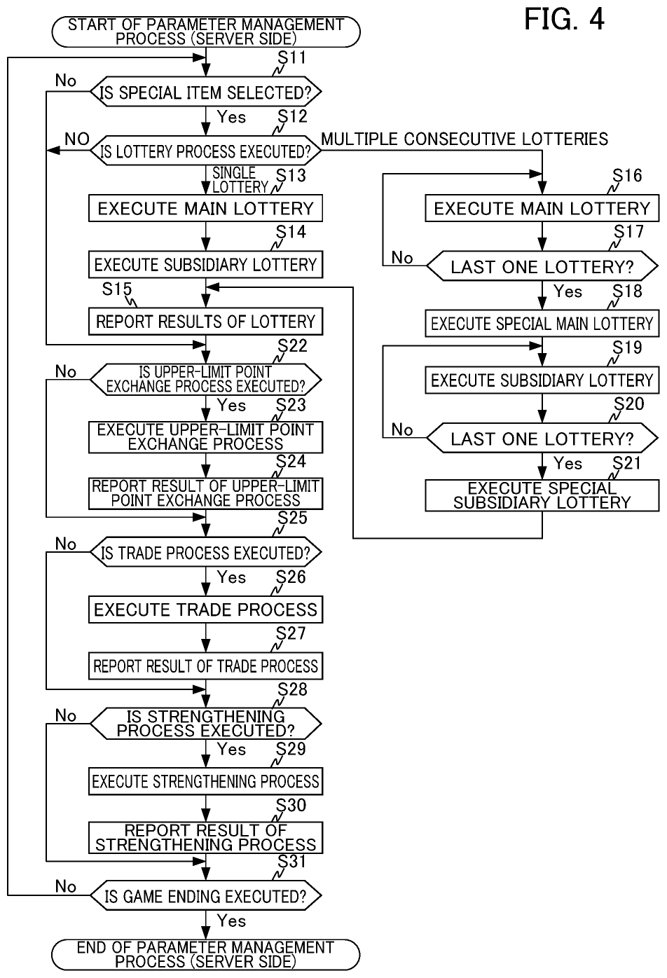

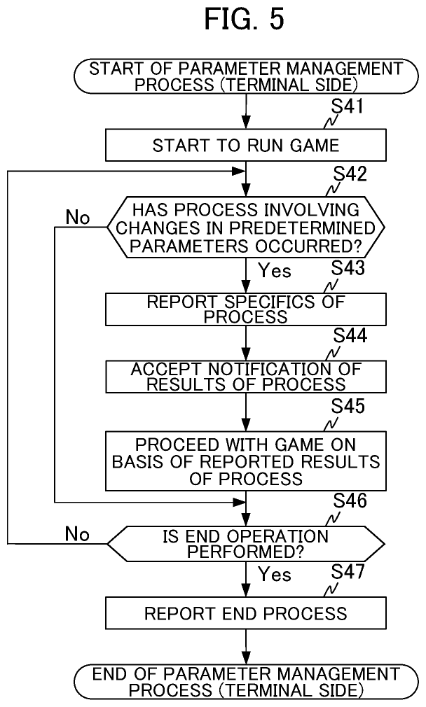

The functional blocks of the player terminal 2 and the server 1 have been described above. Next, the operations in the parameter management process executed by the server 1 and the player terminal 2 will be described with reference to FIGS. 4 and 5. Here, FIG. 4 is a flowchart for illustrating the flow of the parameter management process on the server 1 side. In addition, FIG. 5 is a flowchart for illustrating the flow of the parameter management process on the player terminal 2 side.

The parameter management process is executed when the player performs, for example, a game start operation. Although not particularly mentioned in the following description of the parameter management process, the parameter management process presumes that each of the functional blocks of the server 1 and each of the functional blocks of the player terminal 2 execute, as appropriate and as needed, computation and communication needed to execute the parameter management process and run the game.

First, a flow of the parameter management process on the server 1 side will be described with reference to FIG. 4.

In step S11, the main lottery unit 112 determines whether or not a special item corresponding to one of the characters is selected. In the case where a special item corresponding to one of the characters is selected, the determination in step S11 results in Yes, and processing proceeds to step S12. On the other hand, in the case where no special item corresponding to one of the characters is selected, the determination in step S11 results in No, and processing proceeds to step S22.

In step S12, the main lottery unit 112 determines whether or not a lottery process needs to be executed and, if a lottery process needs to be executed, also determines specifics of the lottery process. In the case where no lottery process needs to be executed, the determination in step 12 results in “No”, and processing proceeds to step S22. On the other hand, in the case where a lottery process needs to be executed and one lottery is executed as one unit, the determination in step 12 results in “single lottery”, and processing proceeds to step S13. In addition, in the case where a lottery process needs to be executed and a plurality (10, here) of lotteries are executed as one unit, the determination in step 12 results in “multiple consecutive lotteries”, and processing proceeds to step S16.

In step S13, the main lottery unit 112 executes the main lottery. In step S14, the subsidiary lottery unit 113 executes the subsidiary lottery.

In step S16, the main lottery unit 112 executes the main lottery.

In step S17, the main lottery unit 112 determines whether or not the main lottery executed in preceding step S16 is the last lottery of the plurality (10, here) of lotteries. In the case where the main lottery executed in preceding step S16 is the last lottery, the determination in step 17 results in Yes, and processing proceeds to step S18. On the other hand, in the case where the main lottery executed in preceding step S16 is not the last lottery, the determination in step 17 results in No, and processing returns to step S16, where the main lottery is executed again.

In step S18, the main lottery unit 112 executes the special main lottery.

In step S19, the subsidiary lottery unit 113 executes the subsidiary lottery.

In step S20, the subsidiary lottery unit 113 determines whether or not the subsidiary lottery executed in preceding step S19 is the last lottery of the plurality (10, here) of lotteries. In the case where the subsidiary lottery executed in preceding step S19 is the last lottery, the determination in step S20 results in Yes, and processing proceeds to step S21. On the other hand, in the case where the subsidiary lottery executed in preceding step S19 is not the last lottery, the determination in step S20 results in No, and processing returns to step S19, where the subsidiary lottery is executed again.

In step S21, the subsidiary lottery unit 113 executes the special subsidiary lottery.

In step S15, the game-running control unit 111 notifies the player terminal 2 of results of the lottery by communication. Here, in the case where the determination in step 12 results in “single lottery”, the reported results of the lottery include the character that has been won in the main lottery in step S13 and a number of the special item that has been won in the subsidiary lottery in step S14.

On the other hand, in the case where the determination in step 12 results in “multiple consecutive lotteries”, the reported results of the lotteries include the characters that have been won in the plurality of main lotteries in step S16, the character that has been won in the special main lottery in step S18, a number of the special items that have been won in the plurality of subsidiary lotteries in step S19, and the special item that has been won in the subsidiary lottery in step S21.

In step S22, the upper-limit point exchange unit 114 determines whether or not an upper-limit point exchange process needs to be executed. Here, the upper-limit point exchange process is a process for awarding the player a character to be drawn in the main lottery in return for consuming a fixed number of exchange points. In the case where the upper-limit point exchange process needs to be executed, the determination in step S22 results in Yes, and processing proceeds to step S23. On the other hand, in the case where the upper-limit point exchange process does not need to be executed, the determination in step S22 results in No, and processing proceeds to step S25.

In step S23, the upper-limit point exchange unit 114 awards the player a character to be drawn in the main lottery in return for consuming a fixed number of exchange points. In short, the upper-limit point exchange unit 114 executes the upper-limit point exchange process.

In step S24, the game-running control unit 111 notifies, by communication, the player terminal 2 that a fixed number of exchange points have been consumed as a result of the upper-limit point exchange process and a character has been awarded to the player.

In step S25, the trade unit 115 determines whether or not a trade process needs to be executed. Here, the trade process is a process for consuming a fixed number of special items, thereby awarding the player a character corresponding to these special items. In the case where the trade process needs to be executed, the determination in step S25 results in Yes, and processing proceeds to step S26. On the other hand, in the case where the trade process does not need to be executed, the determination in step S25 results in No, and processing proceeds to step S28.

In step S26, the trade unit 115 consumes a fixed number of special items, thereby awarding the player a character corresponding to these special items. In short, the trade unit 115 executes the trade process.

In step S27, the game-running control unit 111 notifies, by communication, the player terminal 2 that a fixed number of special items have been consumed as a result of the trade process and a character has been awarded to the player.

In step S28, the strengthening unit 116 determines whether or not a strengthening process needs to be executed. Here, the strengthening process is a process for consuming a fixed number of special items, thereby strengthening a character that is possessed by the player and that corresponds to these special items. In the case where the strengthening process needs to be executed, the determination in step S28 results in Yes, and processing proceeds to step S29. On the other hand, in the case where the strengthening process does not need to be executed, the determination in step S28 results in No, and processing proceeds to step S31.

In step S29, the strengthening unit 116 consumes a fixed number of special items, thereby strengthening a character that is possessed by the player and that corresponds to these special items. In short, the strengthening unit 116 executes the strengthening process.

In step S30, the game-running control unit 111 notifies, by communication, the player terminal 2 that a fixed number of special items have been consumed as a result of the strengthening process and a character has been strengthened.

In step S31, the game-running control unit 111 determines whether or not the game needs to be ended. In the case where the game needs to be ended, the determination in step S31 results in Yes, and this processing ends. On the other hand, in the case where the game does not need to be ended, the determination in step S31 results in No, and processing returns to step S11, where the above-described processing is repeated.

Next, a flow of the parameter management process in the player terminal 2 will be described with reference to FIG. 5.

In step S41, the game-running execution unit 211 starts to run the game.

In step S42, the game-running execution unit 211 determines whether or not a process involving changes in the predetermined parameters has occurred. Examples of processes involving changes in the predetermined parameters include the process for executing the main lottery and the subsidiary lottery, the upper-limit point exchange process, the trade process, and the strengthening process described above with reference to FIG. 4. In the case where such a process involving changes in the predetermined parameters has occurred, the determination in step S42 results in Yes, and processing proceeds to step S43. On the other hand, in the case where no such process involving changes in the predetermined parameters has occurred, the determination in step S42 results in No, and processing proceeds to step S46.

In step S43, the game-running execution unit 211 notifies, by communication, the server 1 of specifics of the process that is determined to have occurred in step S42. For example, the server 1 is notified of which process among the process for executing the main lottery and the subsidiary lottery, the upper-limit point exchange process, the trade process, and the strengthening process described above has occurred. Upon receiving this notification, the server 1 determines that the reported process needs to be executed as described with reference to FIG. 4 and executes various kinds of processes. Then, the server 1 notifies, by communication, the player terminal 2 of the results of various kinds of processes, i.e., the results of the processes for executing the main lottery and the subsidiary lottery, the upper-limit point exchange process, the trade process, or the strengthening process, as described above with reference to FIG. 4.

In step S44, the game-running execution unit 211 accepts the results of the processes reported from the server 1.

In step S45, the game-running execution unit 211 proceeds with the game on the basis of the results of the processes that have been accepted in step S44 and that have been reported from the server 1. The game-running execution unit 211 proceeds with the game by, for example, displaying the characters and items that have been won on the basis of the result of the lotteries or indicating that the player has been awarded characters as a result of the upper-limit point exchange process, the trade process, and the strengthening process.

In step S46, the game-running execution unit 211 determines whether or not a game ending operation has been accepted from the player via the player operation notification unit 212. In the case where a game ending operation has been accepted, the determination in step S46 results in Yes, and processing proceeds to step S47. On the other hand, in the case where no game ending operation has been accepted, the determination in step S46 results in No, and processing returns to step S42, where the above-described processing is repeated.

In step S47, the game-running execution unit 211 notifies, by communication, the server 1 to execute an end process. By doing so, this processing ends. In addition, upon receiving this notification, the server 1 determines that an end process needs to be executed and executes the end process, as described above with reference to FIG. 4.

As described above, the parameter management process is executed through cooperative operation between the server 1 and the player terminal 2. According to this parameter management process, a special item corresponding to a character to be drawn in the main lottery can be set as an object to be drawn in the subsidiary lottery. By doing so, the relevance among the plurality of kinds of lotteries including the main lottery and the subsidiary lottery can be increased, whereby the plurality of kinds of lotteries are made more closely related to one another.

Therefore, it is possible to solve the problem with the above-described general techniques in that a plurality of kinds of lotteries have limited relevance to each other, which demeans the subsidiary lottery as a mere function for awarding a bonus or a prize. In short, according to this parameter management process, in the case where a plurality of kinds of lotteries are executed, the fun of a lottery can be further enhanced.

In addition, in the course of the parameter management process, the upper-limit point exchange process, the trade process, and the strengthening process are executed. By doing so, the player can be provided with the following three means for acquiring a character: winning a character in the main lottery; exchanging exchange points in the upper-limit point exchange process; and trading in special items for a character in the trade process. Furthermore, the player can be provided with the following two means for using special items awarded in the subsidiary lottery: trading in special items for a character in the trade process; and strengthening a character in the strengthening process. Thus, the player is given more options regarding a plurality of kinds of lotteries and can be more strategic in drawing a lottery.

In short, according to the parameter management process, in the case where a plurality of kinds of lotteries are executed, the fun of a lottery can be further enhanced. [Display examples]

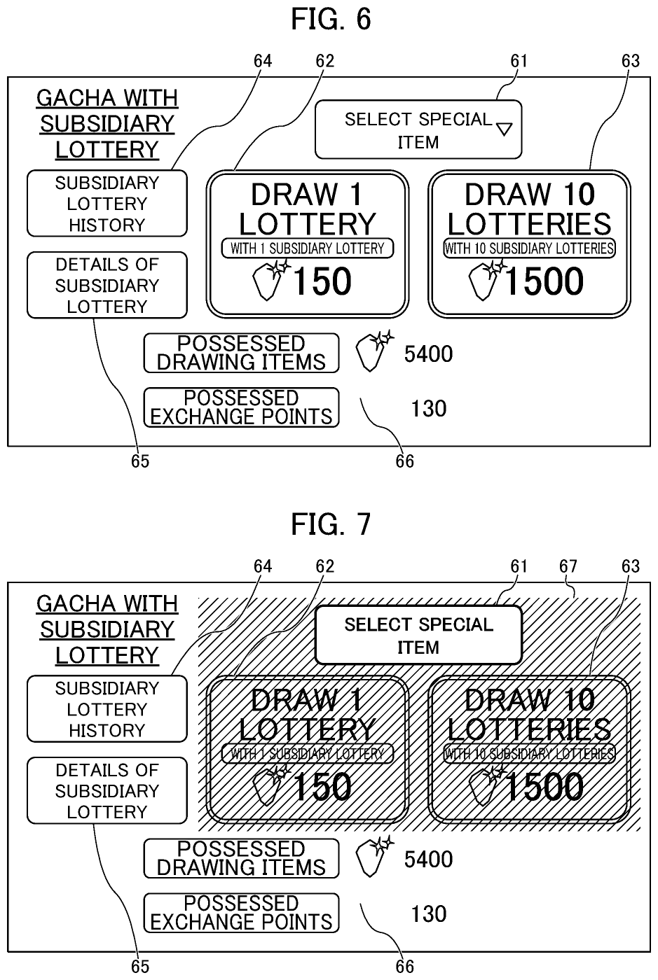

Next, examples of the display screen that is displayed, on the display connected to the output unit 27, as a result of being controlled by the game-running execution unit 211 in the course of the parameter management process will be described with reference to FIGS. 6 to 9. FIGS. 6 to 9 are schematic diagrams showing examples of this display screen.

FIG. 6 is a diagram showing an example of a selection screen that is displayed in the parameter management process and that is related to the main lottery and the accompanying subsidiary lottery (captioned “gacha with subsidiary lottery” in the figure). When making selection regarding the main lottery and the accompanying subsidiary lottery, the player performs an operation for transitioning to this screen.

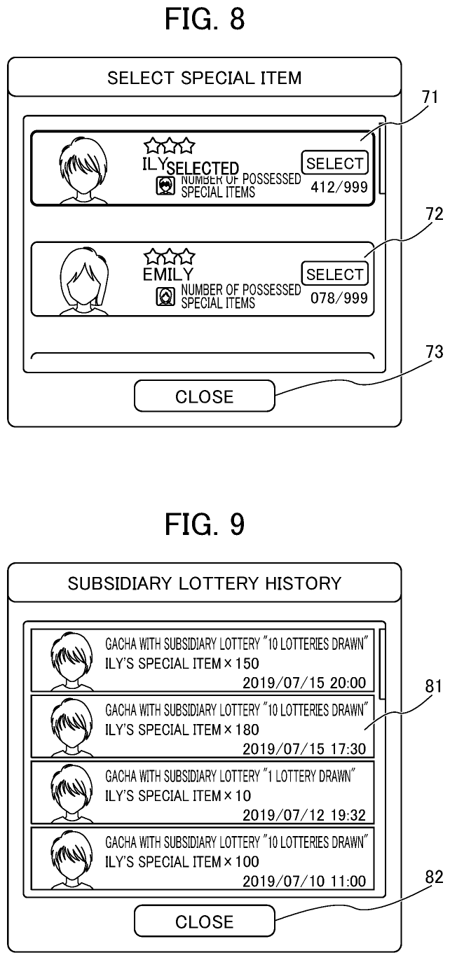

In the display example shown in FIG. 6, a button for selecting a special item corresponding to one of the characters is displayed, as shown by a visual indication 61. When this button is selected via the player's operation, the current screen transitions to a screen for selecting a special item, which will be described below with reference to FIG. 8.

In addition, a button for executing the main lottery and the subsidiary lottery in each of which one lottery is executed as one unit is displayed, as shown by a visual indication 62. This button also indicates that the main lottery has one accompanying subsidiary lottery. In addition, this button indicates the number of lottery items (e.g., “150”) needed to execute the lotteries. When this button is selected via the player's operation, the process for executing the main lottery and the subsidiary lottery in each of which one lottery is executed as one unit is executed in return for consuming the number of lottery items (e.g., “150”) needed to execute the lotteries.

Furthermore, a button for successively executing the main lottery and the subsidiary lottery in each of which a plurality (10, here) of lotteries are executed as one unit is displayed, as shown by a visual indication 63. This button also indicates that the main lottery has ten accompanying subsidiary lotteries. In addition, this button indicates the number of lottery items (e.g., “1500”) needed to execute the lotteries. When this button is selected via the player's operation, the process for executing the main lottery and the subsidiary lottery in each of which a plurality of lotteries are executed as one unit is executed in return for consuming the number of lottery items (e.g., “1500”) needed to execute the lotteries.

Furthermore, a button for referring to the history of the special items that have been won in the subsidiary lottery is displayed, as shown by a visual indication 64. When this button is selected via the player's operation, the current screen transitions to a screen for displaying a subsidiary lottery history, which will be described below with reference to FIG. 9.

Furthermore, a button for referring to the specifics of the subsidiary lottery is displayed, as shown by a visual indication 65. When this button is selected via the player's operation, information similar to the content of the subsidiary lottery table stored in the subsidiary lottery table storage section 183 is displayed. For example, classes in the lottery, the winning probability of each of the classes, and the number of special items awarded to the player when each of the classes is won are displayed in association with one another. The player can determine whether or not to execute the main lottery and the subsidiary lottery for himself/herself after understanding winning probabilities, etc. with reference to this information.

Furthermore, the number of lottery items possessed by the player and the number of exchange points possessed by the player are displayed, as shown by a visual indication 66. With reference to this information, the player can determine whether or not to execute the main lottery and the subsidiary lottery and also whether or not to execute the upper-limit point exchange for himself/herself.

FIG. 7 is a diagram showing another example of the selection screen that is displayed in the parameter management process and that is related to the main lottery and the accompanying subsidiary lottery. As described above, it is necessary to allow the player to select a special item corresponding to one of the characters at least before the execution of the subsidiary lottery. For this reason, if no special items are selected, the display appears as shown not in FIG. 6 but in FIG. 7.

More specifically, the display example shown in FIG. 7, although displaying information similar to the information displayed in FIG. 6, indicates that the visual indication 62 and the visual indication 63 cannot be selected, as further shown by a visual indication 67. Although the visual indication 67 is hatched in the figure, the visual indication 62 and the visual indication 63 may be dimmed or hidden. On the other hand, the visual indication 61 is displayed as a selectable button, as in FIG. 6. Moreover, the visual indication 62 and the visual indication 63 are not only displayed as non-selectable but also designed so as not to accept a selection operation. By doing so, before the player can execute the main lottery and the subsidiary lottery by selecting a button in the form of the visual indication 62 or the visual indication 63, he/she can be prompted to select a special item corresponding to one of the characters by selecting the button in the form of the visual indication 61.

Then, after the player has selected a special item corresponding to one of the characters, the display as in FIG. 6 appears, allowing the player to execute the main lottery and the subsidiary lottery. Note that in the case where there is no room for selecting a special item because there is only one character to be drawn in the main lottery, the special item corresponding to this one character to be drawn may be automatically selected, instead of allowing the player to select the special item.

FIG. 8 is a diagram showing an example of a screen, displayed in the parameter management process, for selecting a special item corresponding to one of the characters. As described above, when the button shown by the visual indication 61 is selected via the player's operation on the display in FIG. 6 or 7, the display in FIG. 6 or 7 transitions to the display in FIG. 8.

As shown by a visual indication 71 and a visual indication 72, the display example shown in FIG. 8 indicates images of the to-be-drawn characters, the levels of rarity of the to-be-drawn characters (in the figure, each of the levels of rarity is indicated by the number of star icons), the names of the to-be-drawn characters, the number of special items that are possessed by the player and that correspond to each of the to-be-drawn characters, etc. In the figure, it is assumed as an example that the special item corresponding to the to-be-drawn character indicated by the visual indication 71 is selected via the player's operation. For this reason, the text “selected” is displayed in the visual indication 71. Note that even after the special item corresponding to the to-be-drawn character has been selected via the player's operation, a special item corresponding to a different to-be-drawn character can be re-selected via the player performing another operation.

In addition, a button for closing the display in FIG. 8 is displayed, as shown by a visual indication 73. When this button is selected via the player's operation, the display in FIG. 8 transitions to the display in FIG. 6 if a special item is selected or to the display in FIG. 7 if no special item is selected.

FIG. 9 is a diagram showing an example of a screen that is displayed in the parameter management process and that displays the subsidiary lottery history. As described above, when the button shown by the visual indication 64 is selected via the player's operation on the display in FIG. 6 or 7, the display in FIG. 6 or 7 transitions to the display in FIG. 9.

The display example shown in FIG. 9, as shown by a visual indication 81, displays whether the main lottery and the subsidiary lottery in which one lottery is executed as one unit were executed or the main lottery and the subsidiary lottery in which a plurality (10, here) of lotteries are executed as one unit were successively executed. The subsidiary lottery history screen also displays the dates and times at which individual main lotteries and subsidiary lotteries were executed, the images and the names of to-be-drawn characters corresponding to the special items selected at those times, and the number of special items that were won. The player can grasp an approximate number of special items that have been won by referring to this display and can further determine whether or not to execute the main lottery and the subsidiary lottery for himself/herself. For characters, the player only needs to grasp whether or not characters have been acquired ultimately. For special items, however, the player also needs to grasp how many special items have been acquired ultimately. Therefore, the above-described display is also informative in this respect. Particularly in the case where a special item can also be acquired by a method other than the subsidiary lottery, it is informative to grasp how many special items have been won in the “subsidiary lottery”, as described above.

In addition, a button for closing the display in FIG. 9 is displayed, as shown by a visual indication 82. When this button is selected via the player's operation, the display in FIG. 9 transitions to the display in FIG. 6 if a special item is selected or to the display in FIG. 7 if no special item is selected.

As in the display examples described above, in the above-described parameter management process of this embodiment, necessary information suitable for the purposes of display screens corresponding to game scenes is displayed in such a manner as to be easily understandable to the player, and appropriate user interfaces can also be presented.

### [Modifications]

Although an embodiment of the present invention has been described above, the embodiment is merely an example and does not limit the technical scope of the present invention. The present invention can be embodied in various other forms, and it is possible to make various modifications, such as omission and substitution, without departing from the spirit of the present invention. These embodiments and modifications thereof are encompassed in the scope and spirit of the invention disclosed in this description, etc. and are encompassed in the scope of the invention recited in claims and equivalents thereof.

### <First Modification>

In the above-described embodiment, it is assumed that only a special item is awarded in the subsidiary lottery. Without the present embodiment being limited to this configuration, an item other than a special item may be awarded. In addition to a special item, for example, a different item that can be exchanged with a special item corresponding to any character, and a different item that can be used in other games may be awarded. By doing so, items awarded in the subsidiary lottery can be made more diverse.

Note that, in this case, when a lower class is won in the subsidiary lottery, an item other than a special item may be awarded. However, from the viewpoint of enhancing fun of a lottery in the case where a plurality of kinds of lotteries are executed, it is necessary to award a special item at least when a higher class is won in the subsidiary lottery.

### <Second Modification>

In the above-described embodiment, it is assumed as an example that the number of exchange points needed to execute the upper-limit point exchange process is 300 and the number of special items needed to execute the trade process is 150.

In the above-described embodiment, it is also assumed that the number of exchange points to be awarded in one main lottery is one and that the number of special items to be awarded in one subsidiary lottery can be two or more. Furthermore, it is not particularly assumed that the winning probabilities for classes with which special items are won in the subsidiary lottery are set to be extremely low. For this reason, it is highly likely that the player is awarded special items needed for the trade process before he/she is awarded exchange points needed to execute the upper-limit point exchange process.

Without the present embodiment being limited to this configuration, the embodiment may be configured so that the player is more likely awarded special items needed to execute the trade process at a timing similar to that at which he/she is awarded exchange points needed to execute the upper-limit point exchange process. Alternatively, the embodiment may be configured so that the player is more likely awarded special items needed to execute the trade process after he/she is awarded exchange points needed to execute the upper-limit point exchange process. This purpose can be achieved by decreasing the number of exchange points needed to execute the upper-limit point exchange process or increasing the number of special items needed to execute the trade process. Alternatively, this purpose can be achieved by increasing the number of exchange points awarded in one main lottery. Alternatively, this purpose can be achieved by setting the winning probabilities for classes with which special items are won in the subsidiary lottery to be lower.

By doing so, settings reflecting the intent of the game administrator can be made.

### <Third Modification>

In the above-described embodiment, it is assumed that the subsidiary lottery is executed accompanying the main lottery (i.e., gacha provided with the subsidiary lottery is executed). Without the present embodiment being limited to this configuration, the embodiment may be configured so that only the main lottery can be executed (i.e., normal gacha is executed). This purpose can be achieved by allowing the player to select between executing the subsidiary lottery accompanying the main lottery and executing only the main lottery.

In this case, a to-be-drawn object awarded in the case where only the main lottery is executed may be identical to or different from a to-be-drawn object awarded in the main lottery in the case where the main lottery accompanied by the subsidiary lottery is executed. If the to-be-drawn objects in the above-described two cases are made to differ from each other, then characters serving as the to-be-drawn objects may differ from each other. Alternatively, winning probabilities for the to-be-drawn characters or winning probabilities for levels of rarity may be made to differ from each other, though the characters serving as the to-be-drawn objects themselves are same.

By doing so, the player can be more strategic in executing a lottery because the player is awarded another option of executing only the main lottery.

### <Fourth Modification>

In the above-described embodiment, the player is awarded a character to be drawn in the main lottery in return for consuming a fixed number of exchange points in the upper-limit point exchange process. Without the present embodiment being limited to this configuration, exchange points may be used for other purposes. For example, the player may be awarded a special item in return for consuming a fixed number of exchange points (e.g., a number of points smaller than the fixed number of points in the upper-limit point exchange process).

By doing so, the player can be given an option of exchanging exchange points for a special item before the fixed number of exchange points in the upper-limit point exchange process are acquired. For this reason, the player can be more strategic in executing lotteries.

### <Fifth Modification>

In the above-described embodiment, it is assumed that the player is awarded a special item only by executing the subsidiary lottery. Without the present embodiment being limited to this configuration, the player may be awarded a special item by another method in some cases. For example, the player may be awarded a special item when he/she clears an event, beats an enemy character, etc. in the course of executing the game (here, RPG as described above).

### <Sixth Modification>

In the above-described embodiment, the server 1 and the player terminal 2 are implemented as separate devices. Without the present embodiment being limited to this configuration, all functional blocks of the server 1 and all functional blocks of the player terminal 2 may be implemented in a single device. In other words, all functional blocks in the above-described embodiment may be realized by a single device. With such a modification, it is also possible to realize a process equivalent to the above-described parameter management process.

In addition, although the above-described embodiment has been described by way of an example where the server 1 and the player terminal 2 to which the present invention is applied are a server device, a game machine, and a smartphone, the server 1 and the player terminal 2 are not limited particularly to those devices. The present invention can be applied to general electronic devices having an information processing function. Furthermore, the functional configurations of the server 1 and the player terminal 2 may be realized by a single device. Alternatively, the functions of the server 1 may be distributed to a plurality of server devices, such as cloud servers, and realized by the plurality of devices.

In other words, the functional configurations shown in FIG. 3 are merely examples, and the present invention is not limited particularly to these examples. That is, it suffices to provide any device with functions that make it possible to execute the above-described series of processing as a whole, and functional blocks to be used to realize those functions are not limited to those in the example in FIG. 3.

### <Other Modifications>

Furthermore, the functional configurations described above can be executed by hardware, by software, or by a combination of hardware and software. For example, the functional configurations in the embodiment are realized by using a processor that executes computational processing. Processors that can be used in the embodiment include a processor constituted of only information processing devices of various kinds, such as a single processor, a multiprocessor, or a multicore processor, as well as a combination of one of these various kinds of processing device and a processing circuit such as an ASIC (Application Specific Integrated Circuit) or an FPGA (Field-Programmable Gate Array).

In the case where at least some of the functional configurations are executed by software, programs constituting the software are installed into a computer or the like from a network or a recording medium.

The computer may be a computer embedded in special hardware. Alternatively, the computer may be a computer that is capable of executing various functions when various programs are installed therein, such as a general-purpose personal computer.

A recording medium including such a program is implemented by the removable medium 100 in FIG. 2, which is distributed separately from the main unit of a device in order to provide a player with the program, or is implemented by a recording medium or the like that is provided to a player in a state embedded in advance in the main unit of a device. The removable medium 100 is implemented, for example, by a magnetic disk (including a floppy disk), an optical disk, or a magneto-optical disk. The optical disk is implemented, for example, by a CD-ROM (Compact Disk-Read Only Memory), a DVD (Digital Versatile Disk), or a Blu-ray (registered trademark) disc. The magneto-optical disk is implemented, for example, by an MD (Mini-Disk). Furthermore, the recording medium that is provided to a player in a state embedded in advance in the main unit of a device is implemented, for example, by the ROM 12 in FIG. 2 or the ROM 22 in FIG. 2, in which a program is recorded, or a semiconductor memory included in the storage unit 18 in FIG. 2 or the storage unit 28 in FIG. 2.

In this description, steps defining the program recorded in the recording medium may include processing that is not necessarily executed sequentially but is executed in parallel or individually, as well as processing that is executed sequentially in order. Furthermore, steps that are executed according to the program recorded in the recording medium may be executed in an arbitrary order within a scope not departing from the spirit of the present invention.

### EXPLANATION OF REFERENCE NUMERALS

1 Server
2 Player terminal
5 Network
11, 21 CPU
12, 22 ROM
13, 23 RAM
14, 24 Bus
15, 25 Input/output interface
16, 26 Input unit
17, 27 Output unit
18, 28 Storage unit
19, 29 Communication unit
20, 30 Drive
100 Removable medium
111 Game-running control unit
112 Main lottery unit
113 Subsidiary lottery unit
114 Upper-limit point exchange unit
115 Trade unit
116 Strengthening unit
181 Management data storage section
182 Main lottery table storage section
183 Subsidiary lottery table storage section
211 Game-running execution unit
212 Player operation notification unit
281 Game-running data storage section
S Information processing system

1. A non-transitory computer readable medium storing an information processing program that causes a computer to realize:
a main lottery function for awarding a player a first game element that is drawn from among at least one to-be-drawn first game element on the basis of an operation performed by the player;
a trade function for consuming a predetermined second game element and awarding the player a first game element corresponding to the predetermined second game element;
a strengthening function for consuming the predetermined second game element and strengthening a first game element corresponding to the predetermined second game element; and
a subsidiary lottery function for awarding, on the basis of execution of a process regarding the main lottery function, the player a second game element that is drawn from among at least one to-be-drawn second game element including the predetermined second game element corresponding to the at least one to-be-drawn first game element.

2. The non-transitory computer readable medium storing the information processing program according to claim 1,
wherein the subsidiary lottery function selects, before the execution of drawing, the predetermined second game element corresponding to any first game element among the at least one to-be-drawn first game element on the basis of an operation performed by the player and awards the player a second game element that is drawn from among at least one to-be-drawn second game element including said selected predetermined second game element.

3. The non-transitory computer readable medium storing the information processing program according to claim 2,
wherein the subsidiary lottery function sets, among the at least one to-be-drawn first game element, a first game element that has a higher winning probability than another first game element with the same level of rarity as a first game element that can be selected on the basis of an operation performed by the player.

4. The non-transitory computer readable medium storing the information processing program according to claim 1, causing the computer to further realize:
an upper-limit point exchange function that, when the number of drawings executed in the main lottery function reaches a fixed number, awards the player a first game element corresponding to the predetermined second game element on the basis of an operation performed by the player.

5. The non-transitory computer readable medium storing the information processing program according to claim 1,
wherein, when a plurality of drawings are executed in a row on the basis of an operation performed by the player in the form of an instruction operation indicating that the plurality of drawings are executed as one unit, the subsidiary lottery function executes drawing so that the minimum number of wins of the predetermined second game element in one of the drawings is larger than the minimum number of wins in another of the drawings.

6. The non-transitory computer readable medium storing the information processing program according to claim 1,
wherein the subsidiary lottery function treats a process for executing drawing in the main lottery function as the process regarding the main lottery function.

7. The non-transitory computer readable medium storing the information processing program according to claim 1,
wherein the subsidiary lottery function treats a process for granting the player a right to execute drawing in the main lottery function as the process regarding the main lottery function.

8. An information processing device comprising:
main lottery means for awarding a player a first game element that is drawn from among at least one to-be-drawn first game element on the basis of an operation performed by the player;
trade means for consuming a predetermined second game element and awarding the player a first game element corresponding to the predetermined second game element;
strengthening means for consuming the predetermined second game element and strengthening a first game element corresponding to the predetermined second game element; and
subsidiary lottery means for awarding, on the basis of execution of a process regarding the main lottery means, the player a second game element that is drawn from among at least one to-be-drawn second game element including the predetermined second game element corresponding to the at least one to-be-drawn first game element.

9. An information processing system comprising:
a terminal; and a server connected to the terminal so as to be capable of communicating with the terminal,
wherein the terminal includes operation accepting means for accepting an input of an operation from a player,
terminal-side notification means for notifying the server of the operation that is performed by the player and that is accepted by the operation accepting means, and
output means for executing an output based on the notification from the server to the player, and
the server includes main lottery means for awarding the player a first game element that is drawn from among at least one to-be-drawn first game element on the basis of an operation that is performed by the player and that is reported from the terminal,
trade means for consuming a predetermined second game element and awarding the player a first game element corresponding to the predetermined second game element,
strengthening means for consuming the predetermined second game element and strengthening a first game element corresponding to the predetermined second game element,
subsidiary lottery means for awarding, on the basis of execution of a process regarding the main lottery means, the player a second game element that is drawn from among at least one to-be-drawn second game element including the predetermined second game element corresponding to the at least one to-be-drawn first game element, and
server-side notification means for notifying the terminal of a result of drawing in the main lottery means and a result of drawing in the subsidiary lottery means.
